(19) United States
(12) Patent Application Publication
(10) Pub. No.: US 2015/0138275 A1
(43) Pub. Date: May 21, 2015

(54) METHOD FOR GENERATING A PRINTED IMAGE ON AN OBJECT HAVING A CURVED SURFACE

(71) Applicant: HEIDELBERGER DRUCKMASCHINEN AG, HEIDELBERG (DE)

(72) Inventor: MATTHIAS NOELL, WEITERSTADT (DE)

(21) Appl. No.: 14/547,365

(22) Filed: Nov. 19, 2014

(30) Foreign Application Priority Data
Nov. 19, 2013 (DE) 102013019359.1

(51) Int. Cl. B41J 25/304

(52) U.S. Cl. CPC B41J 25/304
USPC 347/37

(57) ABSTRACT

A method for generating a printed image on an object having a curved surface includes providing an inkjet printing apparatus with at least one row of nozzles including a number of adjacent nozzles ejecting ink droplets, providing a manipulator guiding the printing apparatus on the manipulator, guiding the printing apparatus along the surface to print a first strip and a second strip laterally adjoining the first strip in joint locations, actuating the manipulator for guiding the printing apparatus along the second strip with different inclinations of the row of nozzles when printing the second strip and when printing the first strip in at least one joint location. The first nozzle is assigned to a position on the surface to which a virtual nozzle adjacent the last nozzle is assigned, in this joint location on the first strip. Alternatively, the printing apparatus may be stationary and the object may be moved.

### CROSS-REFERENCE TO RELATED APPLICATION

This application claims the priority, under 35 U.S.C. §119, of German Patent Application DE 10 2013 019 359.1, filed Nov. 19, 2013; the prior application is herewith incorporated by reference in its entirety.

### BACKGROUND OF THE INVENTION

### Field of the Invention

The present invention relates to a method for creating a printed image on an object having a curved surface which includes providing an inkjet printing apparatus including at least one row of nozzles having a number of mutually adjacent nozzles for ejecting ink droplets, providing a manipulator for guiding the printing apparatus disposed on the manipulator, and guiding the printing apparatus along the surface to print a first strip and a second strip laterally adjoining the first strip in joint locations. The method also relates to a method for creating a printed image on an object having a curved surface which includes providing an inkjet printing apparatus including at least one row of nozzles having a number of mutually adjacent nozzles for ejecting ink droplets, providing a manipulator for guiding the object disposed on the manipulator, and guiding the object along the printing apparatus to print a first strip and a second strip laterally adjoining the first strip in joint locations.

The technical field of the invention is the treatment of three-dimensional object surfaces. The invention, in particular, refers to printing on three-dimensional object surfaces or creating printed images on three-dimensional object surfaces.

German Patent Application DE 10 2012 006 371 A1, having the same Applicant as the instant application, discloses printing on vehicle body parts, i.e. on three-dimensional objects having surfaces with curves, bends, protrusions, depressions, etc., i.e. applying any desired, preferably multicolored image thereto. For that purpose, a robot arm guides the printing apparatus in the form of an inkjet print head along the surface at a printing distance. The treatment steps disclosed in that publication are preparing data (for printing), preparing the object for taking measurements, measuring the object, revising the data, preparing the object for the printing process, printing and subsequent drying/curing. In practice, creating a printed image out of multiple adjacent printed strips on a three-dimensional surface without any visibly disruptive transitional regions between the print strips has been found to be a particular challenge.

U.S. Patent Application Publication No. 2001/0019340 A1 discloses a device and a method for printing on three-dimensional objects wherein multiple strips are printed onto a curved surface of the object and the minimum distance between the printing apparatus and the object is monitored. Nozzles of the printing apparatus that are too far away from the surface to ensure satisfactory printing are switched off as the apparatus is guided along the respective strip. Thus, it is not envisaged to tilt or incline the printing apparatus.

International Publication No. WO 2009/088864 A1, corresponding to U.S. Patent Application Publication Nos. 2009/0167817, 2012/0200626 and 2013/0314460, also discloses a method for printing on a curved surface of an object in multiple strips using a robot-guided printing apparatus. The inclination of the printing apparatus may vary along a curved path. For example, the publication proposes to determine whether a dot is to be printed at a specific location, based on a starting point of a path and a distance signal. The publication does not disclose tilting or inclining the printing apparatus about an axis that is parallel to the advancing movement when adjacent strips are being printed.

Consequently, the application of the technical methods according to the aforementioned prior art may have the following disadvantages: if no specific steps are taken, disruptive effects that may have a detrimental effect on the visual impression of the printed result cannot be precluded when adjacent strips are being printed with the printing apparatus at varying angles or inclinations.

### SUMMARY OF THE INVENTION

It is accordingly an object of the invention to provide a method for generating a printed image on an object having a curved surface, which overcomes at least some of the hereinafore-mentioned disadvantages of the heretofore-known methods of this general type and which allows three-dimensional objects, i.e. objects that have curved surfaces (also referred to as free shapes), to be printed in multiple strips that seamlessly adjoin each other. This means that laterally adjacent print strips are created without visible and thus disruptive (bright or dark) strips of transition and that the image to be printed continues from one strip to the next without any disruption.

With the foregoing and other objects in view there is provided, in accordance with the invention, a method for creating a printed image on an object that has a curved surface, for example a vehicle body part or a vehicle door, using an inkjet printing apparatus and a manipulator such as a robot arm, which comprises the steps of providing a printing apparatus with at least one row of nozzles that includes a number n of adjacent nozzles D₁ to Oₙ (with n being a natural number) for ejecting ink droplets; providing the manipulator for guiding the printing apparatus, which is disposed on the manipulator preferably as a tool; and guiding the printing apparatus along the surface to print a first strip and a second strip in the process, with the second strip laterally adjoining the first strip. The method is distinguished by the further step of actuating the manipulator for guiding the printing apparatus along the second strip in such a way that the inclination of the row of nozzles when printing the second strip is different from the inclination of the row of nozzles when printing the first strip in at least one joint location, in which the first nozzle D₁ is assigned to a position on the surface to which position a virtual nozzle Dₙ₊₁ that is adjacent the nozzle Dₙ is assigned in this joint location on the first strip.

The method of the invention advantageously allows three-dimensional objects, i.e. objects that have a curved surface (also referred to as free shapes) to be printed in multiple strips that adjoin each other without any seam. Laterally adjacent print strips are created without any visible and thus disruptive (bright or dark) transitional strips and the image to be printed continues from one strip to the other in a desired way without any disruption.

The printing apparatus may print one or more colors (CMYK). The nozzles may be based on known piezoelectric technology. The ink that is applied may be a water-based or a UV-curable ink. In addition, a robot-guided UV curing unit may be provided. The robot is preferably a multi-axis articulated robot guiding the printing apparatus at the so-called tool center point.

In a prepress stage, the image to be printed is preferably divided into strips. In terms of their respective (lateral) width, the strips substantially correspond to the effective width of the row of nozzles, i.e. to the printing width. The strips extend in an advancing direction, which may have curvatures (laterally to the right and left as well as upward and downward). The at least two strips cover the entire area to be printed on the surface. The strips may substantially run in the same direction (forward strips) or in opposite directions (forward and backward strips). A visible spacing (a line that is too bright) or a visible overlap (a line that is too dark) between adjacent strips is preferably to be avoided. The marginal and adjacent print dots of adjacent strips are to be positioned on the surface as if they had been created within one of the two strips.

Surfaces that are extremely curved may require the image to be printed or rather the associated data at least in the second strip and at least in the region of the joint of the edges between the strips to be subjected to a calculated distortion to avoid faulty joints that may have a visibly disruptive effect in the image that has been divided into strips.

There are joint locations between the strips. The printing apparatus reaches these joints on the individual strips at different instants. In other words, the printing apparatus reaches a specific joint location P on the first strip at a time T₁ and on the second strip at a later time T₂. Moreover, at one time, it is the virtual nozzle disposed behind the last nozzle that reaches the joint location, and at the other time, it is the first nozzle that reaches the joint location nozzle. If the printing apparatus has been turned in the meantime. the first nozzle on the second strip may be the nozzle that was the last nozzle on the first strip.

The virtual nozzle does not actually exist, rather it is merely an imaginary auxiliary nozzle that is used to assist in the calculations. It is located at a defined position in the row of nozzles, namely an average nozzle distance w behind the last real nozzle Dₙ. Thus, it will be referred to as nozzle Dₙ₊₁ herein. Another conceivable option is to deactivate the last nozzle Dₙ in the printing process and to use this nozzle or rather its position as the virtual nozzle for the calculation. It is preferred, however, to use all existing real nozzles in the printing process.

The calculation is based on the assumption that the virtual nozzle deposits virtual ink droplets on the surface. The virtual positions of these virtual droplets on the surface are calculated and stored. When the calculation is made for the second strip, i.e. when the control data instructing the manipulator how to guide the printing apparatus for the second strip are calculated, these virtual positions are used to place the real positions of the real droplets of the first nozzle on those virtual positions (thus influencing the position of the entire row of nozzles and of the entire printing apparatus). This process includes a case in which the real positions are placed on a polynomial or a spline or rather on the associated space curve that connects or approximates the virtual positions.

With the objects of the invention in view, there is also provided an alternative method of the invention for generating a printed image on an object that has a curved surface using an inkjet printing apparatus and a manipulator, which comprises the steps of providing a printing apparatus that has at least one row of nozzles with a number n of adjacent nozzles D₁ to Dₙ for ejecting ink droplets; providing the manipulator for guiding the object, which is disposed on the manipulator; guiding the object along the printing apparatus to print a first strip and a second strip, the second strip laterally adjoining the first strip in joint locations. The method is distinguished by the further step of actuating the manipulator for guiding the object along the second path in such a way that the inclination of the object when printing the second strip is different from the inclination of the object when printing the first strip in at least one joint location in which the first nozzle D₁ is assigned to a position on the surface to which position a virtual nozzle Dₙ₊₁ that is adjacent the nozzle Dₙ is assigned in this joint location on the first strip,

In a way, the alternative method is the reverse of the method indicated further above, because in the second method it is the object that is moved by the manipulator and not the printing apparatus. Yet in other respects, the implementation of the method is equivalent, in particular in terms of the calculation of the strips. As will be apparent to those skilled in the art, the important aspect is to generate a relative movement between the printing apparatus and the object.

In accordance with another preferred mode of the method of the invention, adjacent nozzles Dᵢ and Dᵢ₊₁ may be spaced apart from each other by a substantially identical distance w and the virtual nozzle Dₙ₊₁ may be provided at the same distance w from the last nozzle Dₙ.

In accordance with a further preferred mode of the method of the invention, the printing apparatus may be guided along the surface at a working distance. Maintaining a working distance ensures that a desired quality of the print (resolution) is attained and collisions with the surface are avoided.

In accordance with an added preferred mode of the method of the invention, the angles or inclinations of the row of nozzles when printing the first strip and the angles or inclinations of the row of nozzles when printing the second strip may differ from each other at most or at all of the joint locations. This case may well occur when the surface has random curvatures. On the other hand, the surface may have planar sections, which means that in certain joint locations, the angle or inclination does not change.

In accordance with an additional preferred mode of the method of the invention, the angles or inclinations of the row of nozzles when printing the first strip and the angles or inclinations of the row of nozzles when printing the second strip may differ from each other in at least one joint location about an axis that is parallel to the advancing direction. This case occurs when the object is curved in a direction perpendicular to the advancing direction of the printing apparatus, e.g. when a tubular object is being printed in strips in the direction of the longitudinal axis.

In accordance with yet another preferred mode of the method of the invention, the angle or inclination of the row of nozzles when printing the first strip and the angle or inclination of the row of nozzles when printing the second strip may differ from each other in at least one joint location about an axis that is parallel to the row of nozzles. This case occurs when the object has curves that differ from the first strip to the second strip in the direction of the advancing movement of the printing apparatus. The two latter cases may occur in combination with each other, for example when spherical objects are being printed in strips. All three cases apply to convex and concave curves alike as well as for any combination of curves in the different directions in space.

In accordance with yet a further preferred mode of the method of the invention, the second strip may be calculated in that initially an a priori strip of the second strip that is laterally adjacent the first strip is calculated without taking into account the positions of virtual droplets of the virtual nozzle. For this purpose, the method disclosed in German Patent Application DE 10 2013 014 444 having the same Applicant as the instant application may be applied.

In accordance with yet an added preferred mode of the method of the invention, the second strip may be calculated in that based on the a priori strip of the second strip, an a posteriori strip of the second strip that is likewise laterally adjacent the first strip is calculated, taking into account the positions of virtual droplets of the virtual nozzle for the calculation. In this case, the method and the associated calculation are carried out in two steps: calculating the second strip in accordance with German Patent Application DE 10 2013 014 444 as an a priori strip and, based thereon, a correctional or more accurate calculation of the second strip as an a posteriori strip in accordance with the distinguishing feature of the invention. Alternatively, all strips of the area to be printed may at first be calculated as a priori strips in accordance with German Patent Application DE 10 2013 014 444, and subsequently all of these strips may be defined more precisely in the course of the calculation of the a posteriori strips. The transition from an a priori strip to an a posteriori strip preferably corresponds to the local displacement of the a priori strip by the order of magnitude of the nozzle distance w to attain the desired seamless joining of the strips,

In accordance with a concomitant preferred mode of the alternative method of the invention in particular, the object may be substantially spherical and may be rotated about at least two axes by the manipulator. This method is particularly suited for printing balls, for example.

Other features which are considered as characteristic for the invention are set forth in the appended claims.

Although the invention is illustrated and described herein as embodied in a method for generating a printed image on an object having a curved surface, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connect on with the accompanying drawings.

### BRIEF DESCRIPTION OF THE SEVERAL VIEWS OF THE DRAWING

FIG. 1 is a diagrammatic, perspective view of a device for carrying out a preferred embodiment of the method according to the invention; and

FIG. 2 is a sectional view of a joint location shown in FIG. 1.

### DETAILED DESCRIPTION OF THE INVENTION

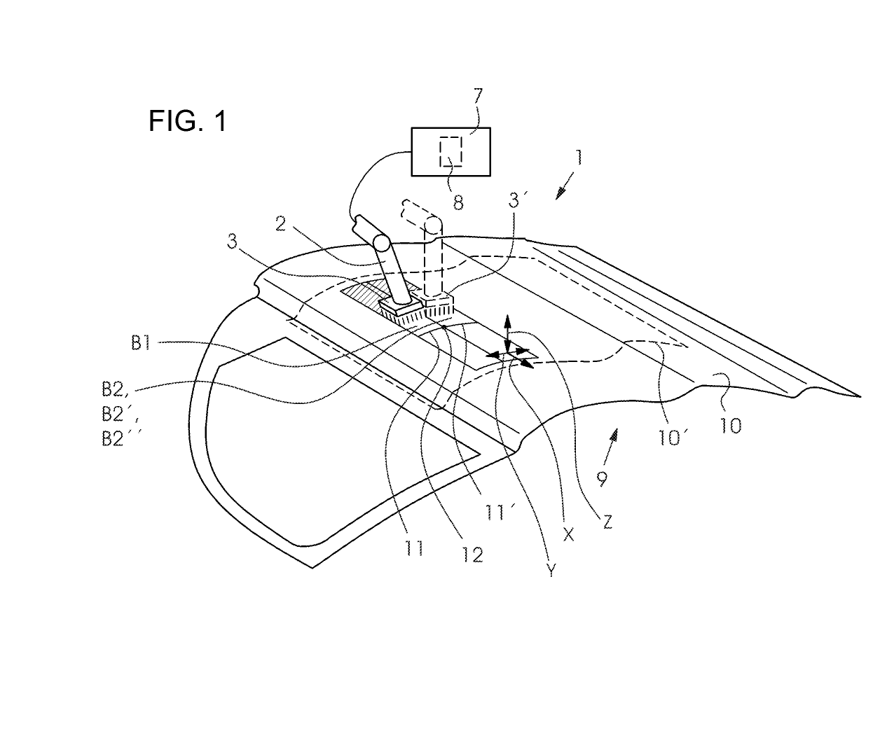

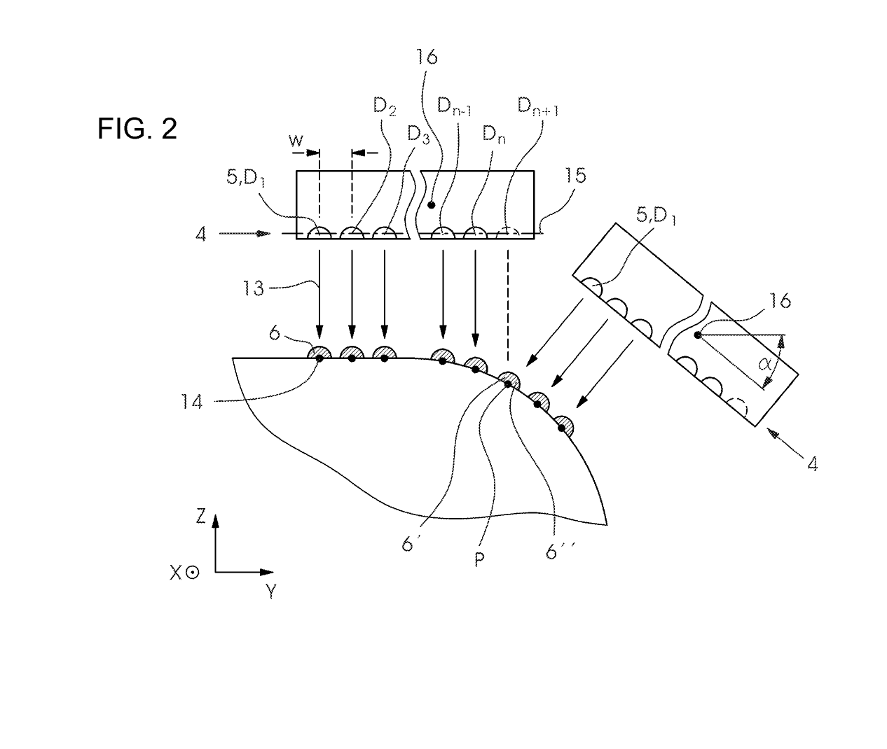

Referring now in detail to the figures of the drawings, in which like reference symbols indicate like elements, and first, particularly, to FIG. 1 thereof, there is seen a diagrammatic, perspective view of a device 1 for carrying out the method of the invention. The device includes a manipulator 2 and a printing apparatus 3 disposed on the manipulator (and illustrated as it is printing a first strip B1). The manipulator 2 may be a robot arm that preferably has six degrees of freedom (e.g. an articulated robot, a linear robot, a parallel robot). The printing apparatus 3 is an inkjet printing apparatus. The robot arm allows the printing apparatus to be guided along an object 9, in particular along its surface 10, maintaining a working distance. This means that the printing apparatus moves within a minimum and a maximum distance from the object surface. The object, which in the illustrated example is a vehicle door, has a curved surface. Since it is advantageous to move a row of nozzles 4 (see FIG. 2) of the printing apparatus 3 substantially tangentially along the surface 10 and at a minimum distance from the surface, it may be necessary to adjust the angle or inclination of the row of nozzles as a function of the local radius of curvature. An adjustment of the angle or inclination may also be necessary due to a finite number of nozzles 5 in the row of nozzles, which means that the strips B1 and B2 have a defined width that cannot be varied at will. The angle or inclination of the row of nozzles may be adjusted by a rotation about a (virtual) axis 15 along the nozzle openings and/or about a (virtual) axis 16 perpendicular thereto and preferably parallel to an advancing movement/direction. A printing apparatus 3′ having an angle of inclination which has been adjusted or which has been rotated is likewise shown in FIG. 1 as it prints the second strip B2.

The printing apparatus 3 has at least one row 4 of nozzles 5 for ejecting ink droplets 6. The ink droplets are ejected in accordance with image data 8 of the image to be printed that have been provided, resulting in the creation of a printed image on the surface 10 or a printing area 10′. As shown in FIG. 1, the printing is done in multiple adjacent strips B1 and B2, which are joined to each other in a lateral direction Y, i.e. perpendicular to an advancing direction X. The transition from one strip to the next is to be invisible to the human eye of an observer who is at a normal viewing distance from the object. In the figure, a position 11 of the row of nozzles 4 when the first strip B1 is being printed and a position 11′ of the row of nozzles 4 when the second strip B2 is being printed are shown at a selected joint location 12, which may be any desired joint location.

FIG. 1 also illustrates an actuating device 7 supplying the manipulator 2 with control data for guiding the printing apparatus 3. In addition, the printing apparatus is supplied with the locally required printing data 8 that correspond to the respective position and orientation in space.

FIG. 2 is a diagrammatic, sectional view of the joint location 12 shown in FIG. 1. In the left-hand section of the figure, the printing apparatus 3 is shown as it prints the first strip B1. In the right-hand section of the figure, the printing apparatus is shown as it prints the second strip B2 at a later point in time. The (real) nozzles D₁, D₂, D₃, . . . Dₙ₋₁, Dₙ of the printing apparatus 3 and associated ejection directions 13 of the ejected ink droplets 6 are shown. The ink droplets reach desired positions 14 on the surface to jointly form the printed image as a solid or halftone area.

In terms of the calculation of the strip data for the second strip B2, the invention is based on the assumption that there is a further nozzle Dₙ₊₁. This nozzle is not actually present in the row of nozzles 4, but it may be referred to as a so-called virtual nozzle. The distance between the virtual nozzle Dₙ₊₁ and the last nozzle Dₙ is the same as a distance w that separates the real nozzles from each other. For the calculation of the second strip, the assumption is made that this virtual nozzle would have deposited a virtual ink droplet 6′ in a position P, i.e. a position is calculated in which the virtual ink droplet ejected by the virtual nozzle would hit the surface 10. This calculation can be made because the position in space of the manipulator 2 or rather of its so-called tool center point and thus of the printing apparatus 3 as the tool on the robot arm and the angle or inclination of the printing apparatus are known. In addition, the ejection direction of the droplets 6 is known or may be approximated as a straight line. The drop speed is also known. Finally, since the position of the object 9 or rather of its surface in space has been measured, the respective position in which the droplet will land may be calculated with sufficient accuracy.

Since this virtual droplet 6′ has not actually been deposited, it will not be deposited until the second strip B2 is printed. The first nozzle D1 thus prints a real ink droplet 6″ precisely in the position P of the virtual droplet 6′ (within the limitations of the accuracy of the movement of the manipulator 2 and the printing accuracy of the printing apparatus 3). This requires the second strip to be calculated in such a way that the first nozzle of the row of nozzles 4 extends precisely along the succession of the virtual print dots of the virtual nozzle Dₙ₊₁ (within the limitations of the control and motion accuracy). In this way, a seamless, invisible joining of the strips may be achieved even when the angle or inclination of the printing apparatus is adapted while the apparatus is being guided. Ways in which to calculate the strips B1 and B2 in general are disclosed, for example, in German Patent Application DE 10 2013 014.2 having the same Applicant as the instant application, which proposes to calculate the strips as polynomials or splines. Such a calculation is preferred in the context of the present invention.

As shown in FIG. 2, in the right-hand section, the printing apparatus 3 has been tilted or inclined. The tilting or inclination has occurred through an angle a about an axis 16 that is parallel to the advancing direction. Due to this adaptation of the angle or inclination, the printing apparatus may be oriented in such a way that the direction of ejection of the ink droplets 6 is approximately perpendicular to the surface 10. Alternatively, an adaptation of the angle or inclination about an axis 15 that is parallel to the row of nozzles is possible. The latter adaptation of the angle or inclination is described in German Patent Application No. DE 10 2013 009 463.1 having the same Applicant as the instant application and is, in particular, intended to compensate the printing speed. Such compensation is preferred in the context of the present invention. It is likewise possible to make adaptations of the angle or inclination about multiple axes 15, 16 at the same time.

Thus, the control unit 7 or a computer associated therewith plans the second strip B2 knowing and using strip planning data of the first strip B1, i.e. as a function of the first strip. Thus, the correct second strip may not be planned, i.e. calculated by a computer until planning and calculations for the first strip have been completed because it is not until then that the positions in which the real and virtual ink droplets 6, 6′ (ejected by the real and virtual nozzles) are available as calculated positions in space or positions on the object surface 10.

The calculation of the second strip B2 or rather of the associated polynomial or spline is preferably done in such a way that in a first step, an a priori strip B2′ is planned; the a priori strip is adjacent the calculated first strip B1, but does not yet take into account the positions P of the virtual droplets 6′ as the joining dots. The a priori strip may thus be planned in the way described in German Patent Application DE 10 2013 014 444. Based thereon, an improved a posteriori strip B2″ that factors in the positions of the virtual droplets as joining dots is planned and calculated for the second strip.

It will be apparent to those skilled in the art that further strips may be planned and calculated in accordance with the method described herein. A following strip will always be generated based on the strip that has been planned and actually calculated before. It is also possible to generate multiple strips as a priori strips in accordance with the method described in German Patent Application DE 10 2013 014 444 and to convert them to a posteriori strips by fine-adjustments, taking into consideration the position of virtual droplets ejected by virtual nozzles in the way described above.

1. A method for generating a printed image on an object having a curved surface, the method comprising the following steps:
providing an inkjet printing apparatus including at least one row of nozzles having a number of mutually adjacent nozzles including a first nozzle and a last nozzle configured to eject ink droplets;
providing a manipulator configured to guide the printing apparatus disposed on the manipulator;
guiding the printing apparatus along the curved surface and printing a first strip and a second strip laterally adjoining the first strip in joint locations;
actuating the manipulator and guiding the printing apparatus along the second strip with an inclination of the row of nozzles when printing the second strip being different than an inclination of the row of nozzles when printing the first strip in at least one of the joint locations; and
assigning a virtual nozzle adjacent the last nozzle on the first strip to a position on the curved surface and assigning the first nozzle on the second strip to the same position, in the at least one joint location on the first strip.

2. The method according to claim 1, which further comprises spacing adjacent nozzles apart from each other by a substantially identical distance and spacing the virtual nozzle apart from the last nozzle by the substantially

3. The method according to claim 1, which further comprises carrying out the step of guiding the printing apparatus along the surface at a working distance.

4. The method according to claim 1, wherein the inclinations of the row of nozzles when printing the first strip and the inclinations of the row of nozzles when printing the second strip differ at most or at all of the joint locations.

5. The method according to claim 1, wherein the inclination of the row of nozzles when printing the first strip and the inclination of the row of nozzles when printing the second strip differ from each other in at least one of the joint locations relative to an axis parallel to an advancing direction.

6. The method according to claim 1, wherein the inclination of the row of nozzles when printing the first strip and the inclination of the row of nozzles when printing the second strip differ from each other in at least one of the joint locations relative to an axis parallel to the row of nozzles.

7. The method according to claim 1, which further comprises calculating the second strip by initially calculating an a priori strip of the second strip being laterally adjacent the first strip, and not taking positions of virtual droplets of the virtual nozzle into account for the calculation.

8. The method according to claim 7, which further comprises calculating the second strip by calculating an a posteriori strip of the second strip also being laterally adjacent the first strip based on the a priori strip of the second strip, and taking the positions of the virtual droplets of the virtual nozzle into account for the calculation.

9. A method for generating a printed image on an object having a curved surface, the method comprising the following steps:
providing an inkjet printing apparatus including at least one row of nozzles having a number of mutually adjacent nozzles including a first nozzle and a last nozzle configured to eject ink droplets;
providing a manipulator configured to guide the object disposed on the manipulator;
guiding the object along the printing apparatus and printing a first strip and a second strip laterally adjoining the first strip in joint locations;
actuating the manipulator and guiding the object along the second strip with an inclination of the object when printing the second strip being different than an inclination of the object when printing the first strip in at least one of the joint locations; and
assigning a virtual nozzle adjacent the last nozzle on the first strip to a position on the curved surface and assigning the first nozzle on the second strip to the same position, in the at least one joint location on the first strip.

10. The method according to claim 9, which further comprises providing the object as a substantially spherical object and rotating the object about at least two axes by using the manipulator.
